(19) United States
(12) Patent Application Publication
(10) Pub. No.: US 2008/0032274 A1
(43) Pub. Date: Feb. 7, 2008

(54) Penis demonstration model

(75) Inventor: Judah Isaacs, Lawrence, NY (US)

Correspondence Address: KATTEN MUCHIN ROSENMAN LLP, 575 MADISON AVENUE, NEW YORK, NY, 10022-2585, US

(73) Assignee: Innovative Premium, Inc.

(21) Appl. No.: 11/700,281

(22) Filed: Jan. 31, 2007

Related U.S. Application Data
(60) Provisional application No. 60/764,409, filed on Feb. 2, 2006.

(51) Int. Cl. G09B 23/00

(52) U.S. Cl. 434/268

(57) ABSTRACT

A penis erection demonstration model including a motor driving a gear assembly, a cam driven by a gear of the gear assembly, a plunger extending from the cam, and an elastic arm extending from a casing of the demonstration model and encasing the plunger. Rotation of the motor in a first direction causes the plunger to extend into the arm a first distance depicting a flaccid state and rotation of the motor in a second direction causes the plunger to extend into the arm a second distance depicting an erect state.

### BACKGROUND OF THE INVENTION

1. Field of the Invention

The invention relates to a training model for medical and educational instructions and particularly, to a model demonstrating an erectile process of a penis.

2. Background of the Invention

Simulators of various parts of the human body for the training and educating of medical personnel and patients are used in medical practice. Be it in an office, where physicians treat patients, or in research and medical laboratories, the role of simulators is important. Simulators may demonstrate how a human body works, assist scientists conducting medical experiments on manikins, and allow patients to communicate competently with physicians.

The use of simulators is particularly popular in the orthopedic, pulmonary and cardiac medical fields. However, many other vital human organs and body parts can be reproduced as demonstration models as well. For example, problems generally related to the urology field and, particularly, to different medical aspects associated with the penis can be demonstrated by a specifically designed model.

It is estimated that over 30 million men in the U.S. experience at least partial erectile dysfunction (ED), impotence and sexual dysfunction. Recently, newly developed medications including, among others, Viagra™ and Lavitra™, have addressed at least some of the existing problems. Having a practical, simple model reproducing the erectile process of the penis may be beneficial, among others, to medical personnel and patients as well as lecturers and students. Heretofore, to the best knowledge of Applicant(s), a standalone penis demonstration model for erectile dysfunction has not been developed in the art.

Thus a need exists for a model demonstrating mechanical functions associated with the erectile process the penis.

Still a further need exists for a portable demonstration model of penis characterized by a simple, easily maintained structure.

Yet, another need exists for a demonstration model of penis having a cost-efficient structure.

### SUMMARY OF THE INVENTION

The present invention is directed to a method and apparatus that satisfy these needs by demonstrating displacement of the penis between flaccid and erect states of an erectile process as well as the shape and dimensions of the penis's body typically associated with these states. Structurally, the inventive apparatus includes an cantilevered section, i.e., an arm made from flexible material and having the shape of the penis. The arm is operative to move and change its shape and dimensions allowing patients to observe and better understand the erectile process.

Displacement of the flexible arm is realized by an actuator and a mechanism configured to transmit the motion of the actuator to the arm. Advantageously, the transmitting mechanism includes a gear train coupling the actuator to a cam means, which, in turn, is coupled to a toggle mechanism. The cam means is configured so that the toggle mechanism and the arm, which are operatively coupled to one another, pivot along an arcuate path and has downstream and upstream stretches that correspond to the flaccid and erect states, respectively. Depending on the direction of the actuator's rotation, the flexible arm moves either from the flaccid state towards the erect state or in the opposite direction from the erect state to the flaccid state.

The cam means is configured with a cam, coupled to the gear train, and a cam follower, slidably mounted in a guide channel, which is provided in the toggle mechanism. The toggle mechanism is configured as a telescopic structure having a barrel and a plunger, which is operative to move within the barrel. The plunger is actuated by the cam follower, which enables the plunger to slide towards and press against the distal end of the arm's body in the erect state. As a result, the overall length and shape of the arm change during displacement of the arm from the flaccid state to the erect state.

The plunger is spring loaded and, thus, is operative to move away from the body's distal end under an action of spring as the arm pivots from the erect state to the flaccid state. As a consequence, once the arm reaches the flaccid state, the length of the body is reduced, and the body's shape is changed.

Thus, the inventive device provides a clear demonstration of the erectile process of the penis. Furthermore, since components of the inventive device are arranged in a space-efficient manner making the device portable, the user can easily transport the inventive device.

These and other features and aspects of the present invention will be better understood with reference to the following description and figures.

### BRIEF DESCRIPTION OF THE DRAWINGS

FIG. 1 is a sectional view of the inventive device having an arm resting in a flaccid state.

FIG. 2 is a top view of the inventive device.

FIG. 3 is a sectional view of the inventive device illustrating the arm in an erect state.

FIG. 4 is a front view of the inventive device; and

FIG. 5 illustrates a gear train transmitting rotational motion of an actuator to the arm.

FIGS. 6a and 6b are sectional views of the model of the present invention in different states in accordance with a further embodiment.

FIG. 7 is a wiring diagram for the model of FIGS. 6a and 6b.

### DETAILED DESCRIPTION

Reference will now be made in detail to several embodiments of the invention that are illustrated in the accompanying drawings. Wherever possible, the same or similar reference numerals are used in the drawings and the description to refer to the same or like parts. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

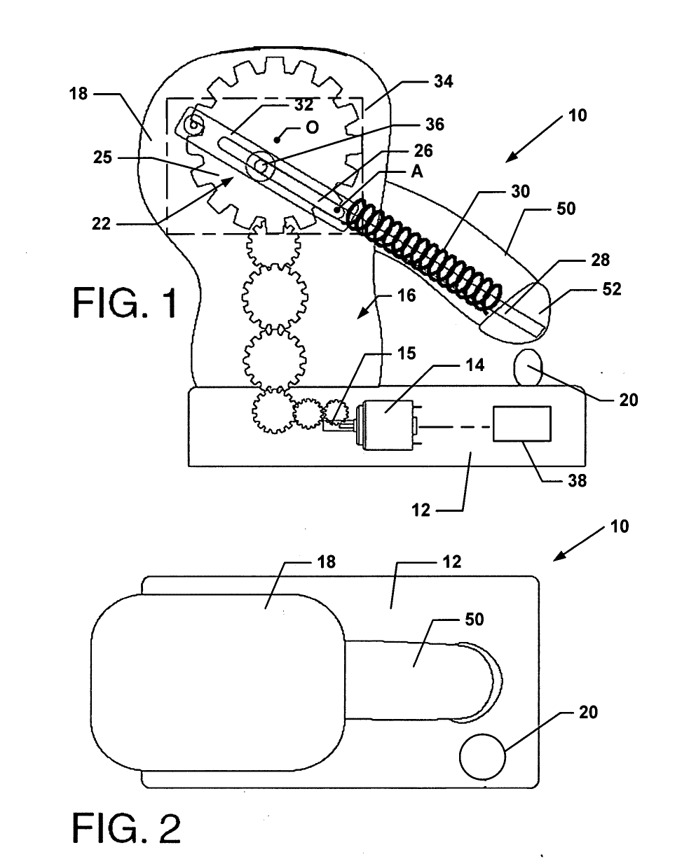

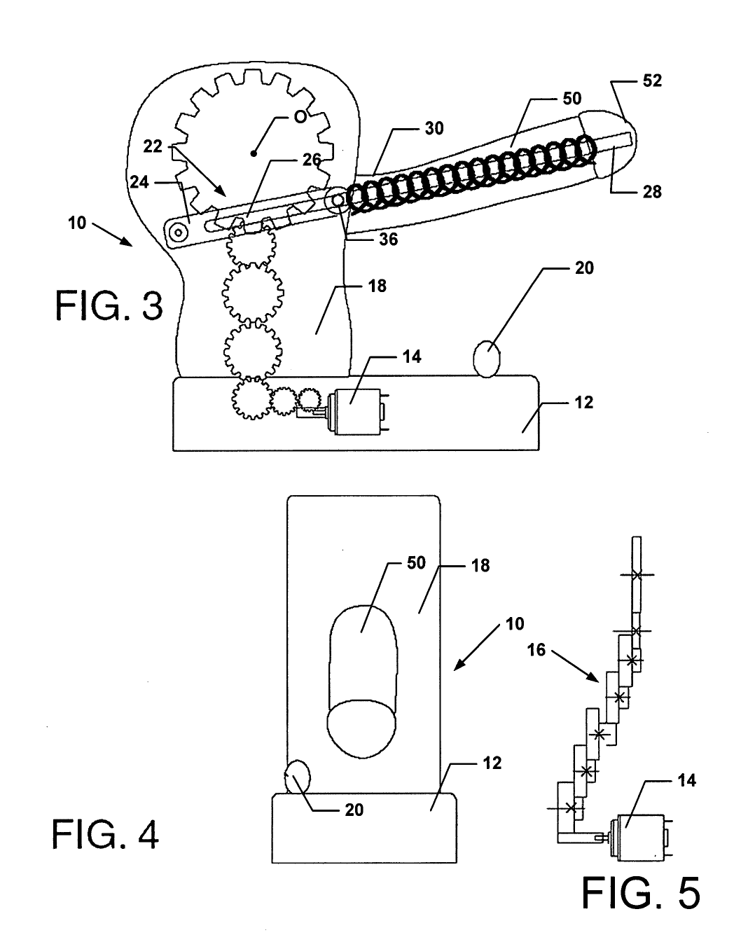

FIGS. 1-4 depict a demonstration model 10, operative to demonstrate displacement of an arm 50, which is in the shape of a penis, during an erectile process characterized by a flaccid state (FIG. 1) and an erect state (FIG. 3). The demonstration model 10 includes a stand 12 and a casing 18. The stand 12 and casing 18 enclose a motor 14 and a gear train 16 configured to displace arm 50 between positions corresponding to the flaccid and erect states of the penis.

To initiate a demonstration of the model 10, a user activates a switch 20, operatively coupled to a power source, such as battery 38, as shown in FIG. 1 and the motor 14. The motor 14, may be selected from a group including, among others, high-speed motors, stepper motors and servomotors. Switch 20 may have a variety of shapes, including, for example, a pill-shaped body, and be selected, among others, from pushbuttons, rockers and slides. Though shown in FIG. 1 as mounted with the stand 12 the battery 38 may be mounted within the casing 18. Alternatively, device 10 may be configured to include a plug-in unit powered by an external source.

Activation of switch 20 energizes the motor 14 and causes a threaded output shaft 15 to rotate. As shown in FIG. 1 the threaded output shaft 15 acts as a worm gear upon a gear of gear train 16 to transmit rotational motion of shaft 15 to gear train 16 and displace arm 50. Exact positioning of gear train 16 and motor 14 within the model 10 is subject to space and cost requirements of the skilled designer. As shown in FIGS. 1 and 3, some of the gears of gear train 16 and motor 14 are mounted in stand 12, whereas the rest of the gears are located in casing 18. Alternatively, casing 18 may house all of the gears, while the motor 14 may remain mounted within stand 12. Gear ratio of gear train 16 can vary and is selected so that persons watching the demonstration can fully understand the nature of the erectile process. Furthermore, depending on whether motor 14 is mounted as shown in FIGS. 1 and 3 or in a different angular position, gears may be selected, among others, from worm and bevel gears.

As is known, the size and shape of the penis changes during the erectile process. To demonstrate this phenomenon, arm 50 pivots between the flaccid state (FIG. 1) and the erect state (FIG. 3). To increase its overall length in the erect state arm 50 extends along an arcuate path by a combination of cam and toggle mechanisms.

The cam mechanism includes a cam 34, shown schematically in FIG. 1, and a cam follower 36. Cam 34 is rotatably fixed to an upstream gear 25 (FIG. 1) of gear train 16 and rotates therewith about a center A (FIG. 1), which is spaced from a center of rotation O of gear 25. Cam 34 is coupled to a proximal end 32 (FIG. 1) of toggle mechanism 22. Movement of the toggle mechanism 22 causes the arm 50 to move so that the model 10 can be displaced between the flaccid and erect states, as shown respectively in FIGS. 1 and 3.

As mentioned before, the arm's length increases as it pivots towards the erect state illustrated in FIG. 3. Since arm 50 is made from polymeric elastic material, such as rubber or plastic, its length can be increased by applying a sufficient tensile force to the arm's distal end 52 (FIGS. 1 and 3), provided, of course, the arm's proximal end is fixed to the casing 18.

Application of the tensile force is realized by toggle mechanism 22 having a barrel 24 (FIG. 3) and a plunger 28 (FIGS. 1 and 3), which is telescopically mounted in barrel 24 and surrounded by arm 50. In the flaccid state of arm 50, a compression spring 30, which is braced by its opposite ends against barrel 24 and plunger 28, forces the plunger away from distal end 52 of arm 50. Thus, in the flaccid state, the distal end of plunger 28 is spaced from the inner surface of distal end 52 of arm 50. As a consequence, arm 50 is not under tension and has a relatively small length.

During rotation of cam 34, its cam surface engages cam follower 36 forcing it to move linearly along a guide channel 26 (FIGS. 1 and 3), provided in barrel 24, and push plunger 28 towards distal end 52 of arm 50. Accordingly, plunger 28 extends from barrel 24 and urges against the inner surface of the arm's distal end 52 with a force sufficient to overcome resistance of the arm's material, which, thus begins to stretch. As a result, the overall length of arm 50 increases, as shown in FIG. 3.

As the arm's length increases, a shape of arm 50 undergoes certain changes due to the elasticity of the arm's material. As illustrated in FIG. 1, arm 50 has generally an upwardly curved or convex shape in the flaccid state. In the erect state, as the body of arm 50 stretches, it assumes a rather downwardly curved or concave shape, as shown in FIG. 3.

Reversing rotation of motor 14 is associated with retracting cam follower 36 to a position of FIG. 1, which, in turn, allows spring 30 to displace plunger 28 from distal end 52 of arm 50. As a consequence, arm 50 returns to its flaccid state.

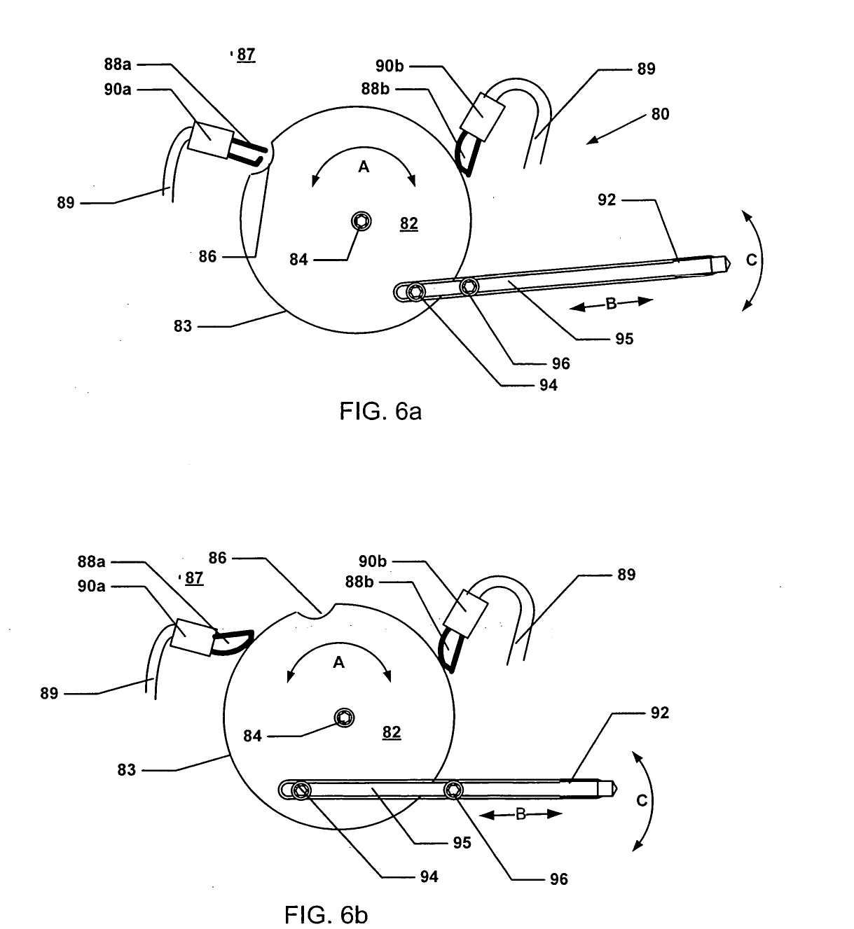

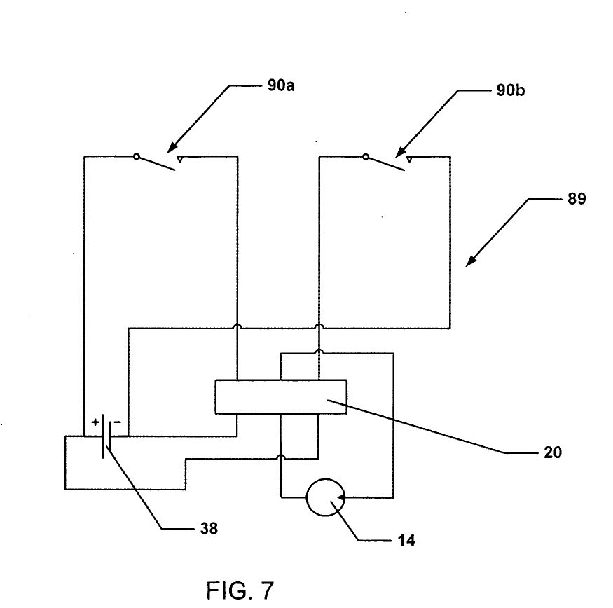

FIGS. 6a, 6b, and 7 illustrate a further embodiment of a demonstration model of the present invention. A model 80 includes a gear train 16, a motor 14, an user operated switch 20, a stand 12, a power source 38, and casing 18 as shown in FIGS. 1, 3, and 5 to demonstrate an erectile process by displacement of a mechanical arm 50. Arm 50 is suitably clad, as shown in FIGS. 1, 3, and 5, to be recognizable as a penis.

Model 80 includes a notched gear 82 in rotational communication via an axle assembly 84 to a gear train such as the one in FIGS. 1, 3, and 5. A motor 14, as shown in FIGS. 1 and 5, which is responsive to user activated switch 20 as well as switches 90a, 90b, drives the gear train. Switches 90a and 90b are mounted to a backing 87 and supported by casing 18.

Gear 82 includes a periphery 83 wherein a notch 86 is suitably sized for leads 88a, 88b of respective switches 90a, 90b. When the leads 88a and 88b pass into the notch 86, the space provided by the notch 86 allows the leads 88a and 88b to become disengaged and interrupt electric flow through wires 89 of the switch. When flow is interrupted, the movement of the arm 50 is stopped and the model has achieved erection or its flaccid state.

Leads 88a, 88b may in one embodiment be flexible metal strips that when engaged, i.e. touching each other, transmit electricity in a predetermined circuit, such as the one in FIG. 7, to power motor 14. Typically, periphery 83 forces the leads together to maintain electric contact, as for example leads 88b illustrated in FIG. 6b, and wherein motor 14 continues in operation to progress in the erectile process or in a returning flaccid process.

When notch 86 is proximal to one of the leads, those leads expand and electric flow is interrupted, as for example leads 88a. At that time, motor 14 stops and the movement of the arm 50 is stopped and the model has achieved erection or its flaccid state. To demonstrate the reverse movement, a user engages switch 20, which preferably is a three-position switch, and the arm reverses direction and accordingly the model progresses from a first state to a second state, such as from a tumescent to a flaccid state or vice versa.

The three-position switch provides electricity to the motor 14 in a first position or start position, despite the fact that one of the switch 90a or 90b is open because the leads 88a or 88b are in a notch 86. Provision of electricity to the motor 14 allows the notched gear 82 rotate. As the notched gear 82 rotates, the leads 88a and 88b are both forced out of the notches 86 and thus their respective contacts are closed. In this position, the switch 20 may be released and the model will continue to operate traversing from flaccid to erect or erect to flaccid positions. Upon release, the switch 20 is in a second position, “normal” position. The third position of the switch 20 operates is the same as the first, but provides for rotation of the motor 14 in the opposite direction as the first position. Thus the notched gear 82 can rotate in the opposite direction.

As with the embodiment shown in FIGS. 1-4, the embodiment shown in FIGS. 6a and 6b simulate the anatomical conditions of a penis moving from erect (FIG. 6a) to flaccid (FIG. 6b). The gear 82 rotates in the circuit shown by arrow arc A.

Fixedly attached to gear 82 is a post 94 and acting as a cam follower in a cam 95 to move plunger 92 with respect to a second post 96. The second post 96 is substantially rigidly mounted to the casing 18 or another suitable point, and remains stationary.

When the gear 82 rotates, post 94 moves relative to an exterior surface of the casing 18 and the length of the plunger 92 changes along a length B. As a result, on model 80 the arm 50 of FIG. 1 shortens and the penis appears to become tumescent or flaccid to an observer.

FIG. 7 illustrates one embodiment of the wiring diagram 100 for an embodiment of model 80 of FIGS. 6a and 6b. Therein, switches 90a, 90b are connected to a power source 38 by one connecting wire 89 and by another connecting wire to user switch 20. Connecting wires from the power sources on the side connected to the switches are provided to the respective other side of the user switch to allow the motor, which is preferably connected to the switch at the center terminals, to be operated in reverse.

This document describes the inventive demonstration model for illustration purposes only. Neither the specific embodiments of the invention as a whole, nor those of its features limit the general principles underlying the invention. In particular, the invention is not limited to a gear train or a two-link toggle mechanism. The gear train may be substituted by a hydraulic or pneumatic structure, whereas the toggle mechanism may have multiple telescopically operating links providing the arm with different sizes, if, of course a need exist. Thus, the specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention.

We claim:

1. A penis erection demonstration model comprising:
a motor driving a gear assembly;
a cam driven by a gear of the gear assembly;
a plunger extending from the cam;
an elastic arm extending from a casing of the demonstration model and encasing said plunger, wherein rotation of the motor in a first direction causes the plunger to extend into the arm a first distance depicting a flaccid state and rotation of the motor in a second direction causes the plunger to extend into the arm a second distance depicting an erect state.

2. The penis erection demonstration model of claim 1, further comprising a switch electrically connected to the motor.

3. The penis erection demonstration model of claim 2, wherein the switch is a three-position switch.

4. The penis erection demonstration model of claim 1, further comprising a compression spring surrounding the plunger.

5. The penis erection demonstration model of claim 4, wherein when the spring is extended, the arm has an upward curvature.

6. The penis erection demonstration model of claim 4, wherein when the spring is retracted, the arm has a downward curvature.

7. The penis erection demonstration model of claim 1, further comprising a cam follower.

8. The penis erection demonstration model of claim 7, further comprising a guide channel, along which a cam follower travels in a first direction to force the plunger to into the arm.

9. The penis erection demonstration model of claim 8, wherein travel of the cam follower in a second direction allow the arm to go flaccid.

10. The penis erection demonstration model of claim 1, further comprising first and second posts.

11. The penis erection demonstration model of claim 10, wherein the first post is connected to the cam and the second post is connected to the casing.

12. The penis erection demonstration model of claim 10, wherein the second post is slidingly engages the cam.

13. The penis erection demonstration model of claim 10, wherein the first post is rotatable with respect to the cam, and drives the cam in a linear fashion when driven by the gear assembly.

14. The penis erection demonstration model of claim 1 comprising at least one pair of rotation stop contacts in sliding engagement with at least one gear of the gear assembly.

15. The penis erection demonstration model of claim 14, wherein at least on gear of the gear assembly includes a notch, wherein when the rotation stop contacts enter the notch the electrical contacts cease to contact each other, stopping movement of the model.

16. The penis erection demonstration model of claim 14, wherein there are two pairs of rotation stop contacts, one opening upon reaching an erect state of the model and one opening upon reaching a flaccid state of the model.
